(19) United States
(12) Patent Application Publication
(10) Pub. No.: US 2006/0006229 A1
(43) Pub. Date: Jan. 12, 2006

(54) Work station

(76) Inventor: Kraig Strom, Corona, CA (US)

Correspondence Address: ALLAN HOWARD GRANT, 1301 DOVE STREET, SUITE 450, NEWPORT BEACH, CA, 92660, US

(21) Appl. No.: 10/885,830

(22) Filed: Jul. 6, 2004

(51) Int. Cl. G06K 15/00

(52) U.S. Cl. 235/383

(57) ABSTRACT

The present invention is for a Work Station, which attaches directly to a cart giving the employees a writing area, a place to store work supplies, and retaining means for holding at least one pricing instrument, marking instrument, scanning instrument, printing instrument, or computing instrument, thereby allowing an employee to work more efficiently as well as reducing the incidents of damage to costly hardware. A Work Station comprises: a cart; a platform; attaching means for connecting said platform to said cart; said platform has retaining means for holding at least one instrument; wherein said retaining means are capable of holding said instruments of various sizes; and wherein an employee needs to utilizes at least one instrument to perform at least one work related task, said employee can remove said instrument from said retaining means to perform said task and said employee can store said instrument in said retaining means when said employee is done with said instrument. The present invention also provides a method of using a work station.

### FIELD OF THE INVENTION

This invention relates to a shopping cart attachment and more particularly a devise for improving the productivity of store employees as well as reducing the incidents of damage to costly hardware.

### BACKGROUND OF THE INVENTION

It is a common practice for employers to routinely have their employees use shopping carts to carry out numerous tasks within the store with store property such as computers, printers, pricing devices, marking devices, scanning devices, and pricing materials. Such tasks include stocking merchandise items, price marking items, marking shelves with item identifications, and preparing, modifying, and reviewing reports and/or taking notes regarding the condition of the store or the placement of products or merchandise in the store.

A major problems that employers are encountering is that costly instruments such as computers, printers, bar scanning devices, bar code label printers, and other pricing and marking devices are often damaged, misplaced or lost, when the devices are carried around by the employees in the shopping cart to perform their work related tasks. As such, it would be useful to have a Work Station that can attach to a shopping cart to prevent store tools and instruments from getting damaged, misplaced or lost.

An additional problem with employees utilizing shopping carts to carry out their work related tasks is that the shopping carts do not have a flat writing surface on which the employees can review, modify, and prepare reports and/or take notes while they are stocking merchandise items, price marking items, and marking shelves with item identifications. As such, it would be helpful for employees to have a Work Station that can attach to a shopping cart to provide a flat writing surface on which the employees can review, modify, and prepare reports and/or take notes.

A further problem that employees encounter, when using a shopping cart for work related tasks is that small items such as pens, pencils, markers, tape, and scissors and other such supplies are susceptible of falling out of the shopping cart because of their small size. As such, it would be helpful for employees to have a container that can attach to the shopping cart and/or the shopping cart platform to store these items.

Further, it is cumbersome for the employees to have to hold and review a report and a writing instrument while retrieving items and/or moving items around when a display is being modified and/or moved. Similarly, it is cumbersome for an employee to hold and review a report and a writing instrument while utilizing hardware such as computers, printers, bar scanning devices, bar code label printers, and other pricing and marking devices. As such, it would be useful for an employee to have a Work Station that can attach to a shopping cart to store pricing and marking devices and reports while the employee is engaged in moving items around the store.

The Work Station is superior to the present methods utilized by store employees because it provides a way to organize and protect store property. Whereas in the previous method, an employee would toss the costly hardware in to a shopping cart when the employee was temporarily finished using it. Furthermore, when the employee was finished with the work related tasks, the costly hardware would sometimes be left in one of the numerous shopping carts instead of being returned to its designated spot for use by other employees. By leaving the various instruments laying around, it is just a matter of time before one or more of the instruments turns up missing.

One of the benefits of the Work Station is that it attaches to a shopping cart which can be found at almost every establishment. In fact, shopping carts are routinely used by employees to move merchandise or products around the store since shopping carts are relatively large and have wheels. Shopping carts are also used for restocking merchandise and for storing returned merchandise before it is put back on the self. Further, shopping carts are used to carry equipment such as computers, printers, bar scanning devices, bar code label printers, and other pricing and marking devices so that the employee can stock merchandise items, price mark items, and mark shelves with item identifications when the employee is altering and/or moving merchandise or products. This common practice can be seen in stores such as Wal-mart, Target, Best Buy, Staples as well as numerous other stores.

Accordingly, there is a substantial need in the art for the Work Station that attaches directly to a shopping cart giving the employees a writing area, a place to store work supplies, and a place to temporarily retain costly hardware such as bar scanning devices, bar code label printers, computers, printers, and other pricing and marking devices thereby improving the productivity of the store employees as well as reducing the incidents of damage to costly hardware. By utilizing a Work Station, an employee will be more organized and efficient and able to carry-out and store all of the necessary instruments for the employee to perform his tasks which include stocking merchandise items, price marking items, and marking shelves with item identifications as well as other store related activities.

### SUMMARY OF THE INVENTION

The present invention specifically addresses and alleviates the above problems that employers and employees are having when the employees routinely use shopping carts to carry out their work related tasks within a retail store, warehouse or stockroom.

The Work Station can be constructed from various plastics or metals to form a base or platform. The platform can be constructed so that it can be attached directly to a shopping cart giving the employee space for carrying pricing material, computers, printers, reports, supplies and the merchandise weather the products are being placed in a store or the stock room.

The Work Station can be constructed so that various instruments such as hand held computers, pricing guns, scanning devices, bar code label printers, and other pricing and marking devices can be quickly stored while the employee is temporarily engaged in other work related tasks, and then readily accessed when the employee again needs one of the instruments to perform another tasks.

It is an object of the present invention to provide a platform that has attaching means for temporarily connecting the platform to a shopping cart.

It is also object of this invention to provide a shopping cart platform that has a stable writing surface for employees to utilize in reviewing, modifying, and preparing reports and/or taking notes while the employee is engaged in various work related tasks through out the store.

It is also object of this invention to provide a shopping cart platform that has means for holding devices such as bar scanning devices, bar code label printers, computers, printers, and other pricing and marking devices.

It is a further object of this invention to provide a shopping cart platform that has a container that can attach to the shopping cart and/or the platform to store items.

It is an additional object of the present invention to provide a method of using a Work Station comprising the steps of providing a platform which has attaching means for connecting said platform to a cart; said platform has retaining means for holding at least one instrument; and wherein an employee needs to utilizes at least one instruments to perform at least one work related task, said employee can remove said instrument from said retaining means to perform said task and said employee can store said instrument in said retaining means when said employee is done with said instrument.

It is an additional object of the present invention to provide a method of using a Work Station comprising the steps of providing a cart; a platform which has attaching means for connecting said platform to said cart; said platform has a writing surface; and wherein an employee needs to utilize said writing surface, said employee can perform at least one work related tasks using said writing surface.

It is an additional object of the present invention to provide a method of using a Work Station comprising the steps of providing a cart; a platform which has attaching means for connecting a platform to said cart; said platform has a writing surface and retaining means for holding at least one instruments; wherein an employee needs to utilize said writing surface, said employee can perform at least one work related tasks using said writing surface; and wherein an employee needs to utilizes at least one instruments to perform at least one work related task, said employee can remove said instrument from said retaining means to perform said task and said employee can store said instrument in said retaining means when said employee is done with said instrument.

It is an additional object of the present invention to provide a method of using a Work Station comprising the steps of providing a cart; a platform which has attaching means for connecting a platform to said cart; said platform has a writing surface and retaining means for holding at least one instruments; said platform has a container for storing items; wherein an employee needs to utilize said writing surface, said employee can perform at least one work related tasks using said writing surface; wherein an employee needs to utilizes at least one instruments to perform at least one work related task, said employee can remove said instrument from said retaining means to perform said task and said employee can store said instrument in said retaining means when said employee is done with said instrument; and wherein said employee uses the container to store and retrieve items while said employee is performing work related tasks in the store.

It is also a further object of the present invention to provide an attachment for use on a shopping cart which is simple in construction and use, economical to manufacture and reliable in performance.

It is yet another object of the present invention to provide an attachment for use on a shopping cart which provides a way to organize and protect store property and also help the employee work more efficiently.

In addition to the above objects, various other objects of this invention will be apparent from careful reading of this specification including the detail description contained herein below.

### BRIEF DESCRIPTION OF DRAWINGS

These as well as other features of the present invention will become apparent upon reference to the accompanying drawings wherein like numerals designate corresponding parts in the several figures, summarized as follows:

FIG. 1 is a perspective view of the Work Station, which is comprised of a platform, retaining means for holding the instruments, and container.

FIG. 2 is a perspective view of the Work Station and a shopping cart and instruments.

FIG. 3 is a perspective view of the Work Station attached to a shopping cart.

FIG. 4 is a bottom view of platform.

FIG. 5 and FIG. 6 are views of the retaining means for holding instruments.

Other features and advantages of the invention will become apparent from the following detailed description, taken in conjunction with the accompanying drawings, which illustrate, by way of example, various features of embodiments of the invention.

### DETAIL DESCRIPTION OF PREFERRED EMBODIMENT

The following detailed description and accompanying drawings are provided for purpose of illustrating and describing presently preferred embodiments of the present invention and are not intended to limit the scope of the invention in anyway. It will be understood that various changes in the details, materials arrangements of parts or operational conditions which have been herein described and illustrated in order to explain the nature of the invention may be made by those skilled in the art within the principles and scope of this invention.

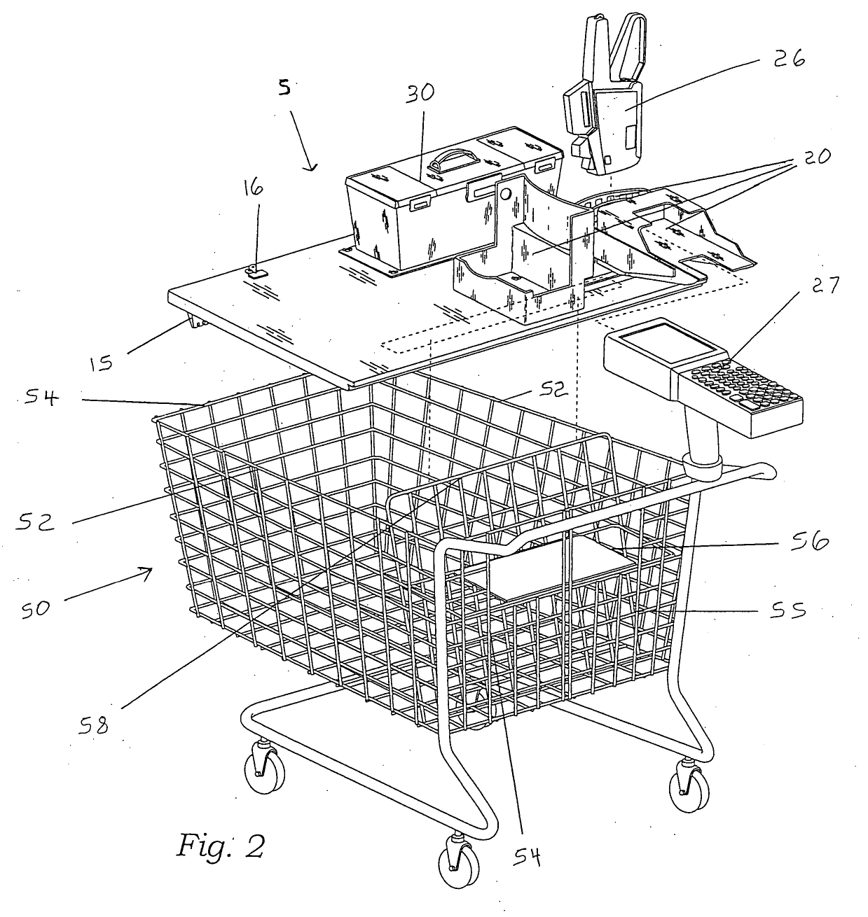

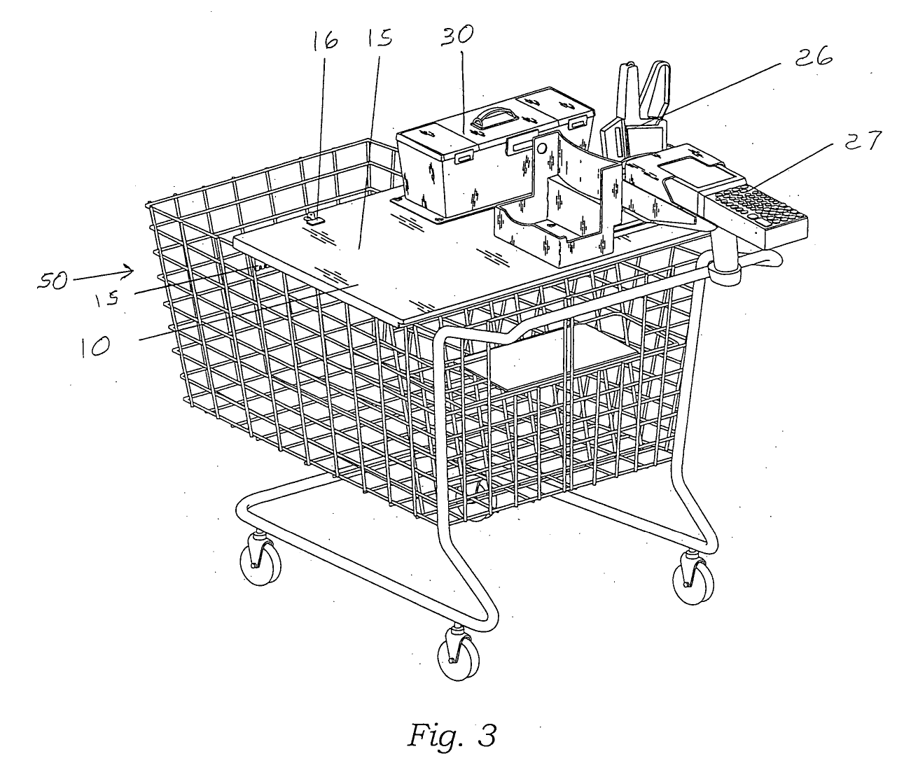

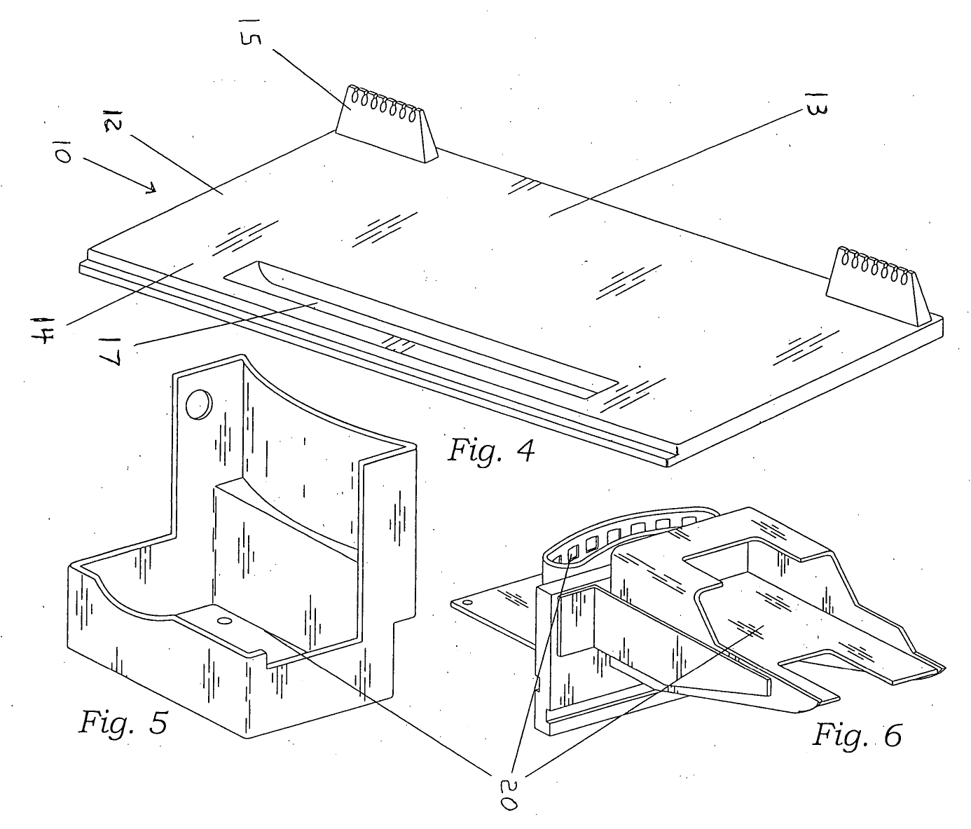

Turning now to the drawings, the present invention is adapted to be used with a conventional shopping cart of the type illustrated in FIGS. 2 and 3. A conventional shopping cart is designated by the numeral 50 and is typical of wire rod construction having opposite side walls 52 and end walls 54 which form a generally cubical basket for reception of merchandise or products. The shopping cart includes a collapsible infant seat 56. The infant seat 56 includes an adjustable inner wall 58 which provides a back for the infant seat 56. The infant seat 56 also includes a seat 57 constructed from a number of rod members, including an end portion, formed around the intermediate transverse rod member to provide a pivotal connection there between. The seat 57 also includes a transverse rod portion which is slidably received within a plurality of guide slots formed by the vertical rod members on the rear wall 55 of the cart. Inner wall 58 movable between adjusted positions wherein the wall is either supported in contact with the rear wall 55 or in an angularly displaced forward position, the seat 57 is adjusted relative to the guide slots to define a seating area on which the infant may sit during use of the shopping cart. The rear wall 55 is pivotally adjustable from a vertically oriented position to a horizontally oriented position, whereby adjacent carts can be nested relative to each other when not in use. The above described shopping cart is of conventional construction and the details of the cart have been described so that an understanding can be obtained of the attaching means of the Work Station.

In an alternative embodiment not shown, the shopping cart can be constructed of plastic instead of wire rod.

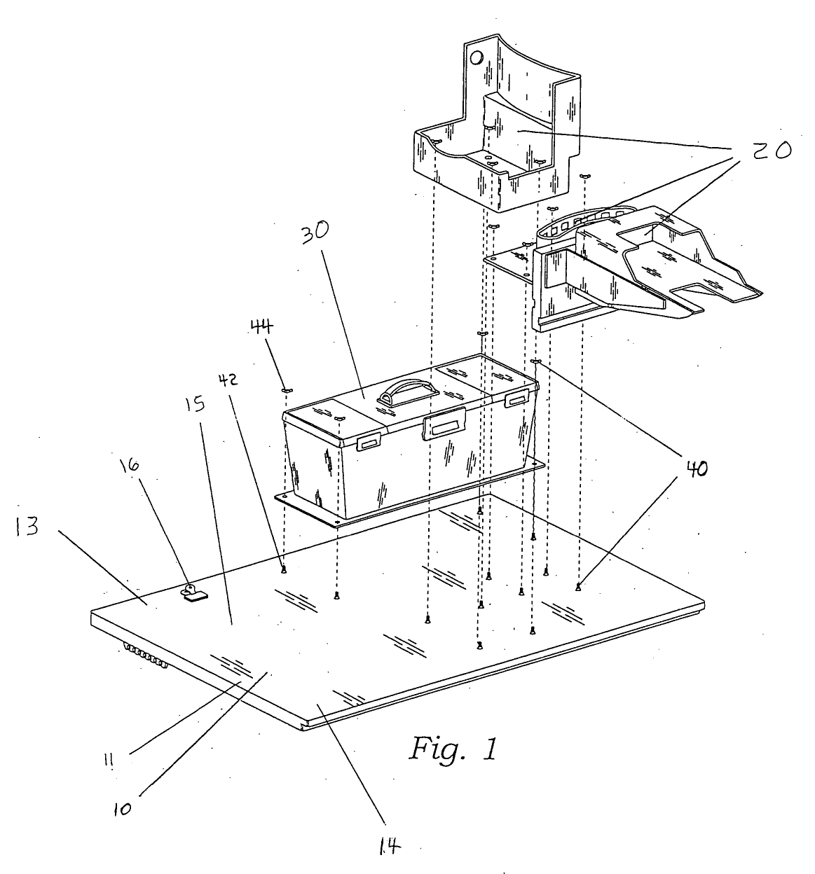

As shown in FIGS. 1-4, the Work Station 5 is comprised of a platform 10 having a top 11 and a bottom 12 and a upper portion 13 and a lower portion 14. In the preferred embodiment of this invention, the platform 10 is constructed from various plastic. The platform 10 of the Work Station 5 includes two main sections, a first section having retaining means 20 for holding and storing pricing and marking instruments and a second section having a writing surface 15 for reviewing, writing, modify, and preparing reports and/or taking notes. A third section can also be utilized where an employee needs a container 30 to store small items.

As shown in FIG. 4, the bottom 12 of the platform 10 has attaching means 15 for connecting the upper portion 13 of the platform 10 to the shopping cart 50. The attaching means 15 of the platform 10 can connect to the side walls 52 of the cart 50 to provide a secure and stable upper surface. The bottom 12 of the platform 10 also has a grove 17 for stabilizing the lower portion 14 of the platform 10. The grove 17 of the platform 10 is positioned on top of the inner wall 58 of the cart 50, when the inner wall is angularly displaced in a forward position, thereby providing a secure and stable lower portion 14 of the platform 10. Since the lower portion 14 of the platform 10 rests on top of the inner wall 58 of the cart 50 and the inner wall 58 is raise higher than the surrounding side walls 52 and end walls 54; in order to ensure a flat uniform surface in the preferred embodiment of this invention, the attaching means 15 for connecting the platform 10 to the side walls 52 of the shopping cart 50 should be raised an inch and a half from the platform 10.

As shown in FIG. 1-3, 5 and 6, the top 11 of the platform 10 has retaining means 20 for holding and storing instruments 25 such as a Garvey pricing gun 26 and a bar scanning device 27, as seen in FIGS. 1-3. In an alternative embodiments not shown, other pricing and marking instruments can be held and stored in the retaining means of the platform. In another alternative embodiment not shown, the retaining means can be modified to hold the various instruments such as bar scanning devices, bar code label printers, computers, printers, and other pricing and marking devices.

As shown in FIGS. 1-3, connecting means 40 such as screws 42 and bolts 44 are used for attaching the retaining means 20 to the platform 10 in the preferred embodiment of this invention. However, in an alternative embodiment not shown, the entire Work Station could be molded as one piece of plastic, thereby eliminating the need for screws and bolts to secure the retaining means to the platform. The molding could be accomplished by an injection mold, a compression mold, a blow mold, or a vacuum mold.

As shown in FIGS. 1-3, the Work Station 5 has a platform 10 that has a writing surface area 15 so that an employee can review, write modify, and prepare reports and take notes regarding various work related tasks. The Work Station also has a spring clip 16 that is secured near upper portion 13 of the top 11 of the platform 10 to secure documents. To ensure a stable and uniform flat writing surface for an employee to work on, it is an object of this invention to rest the grove 17 of the platform 10 on top of the inner wall 58 of the cart 50 and to connect the attaching means 15 to the side walls 52 of the cart 50. Since the surrounding side walls 52 and end walls 54 of the cart 50 are lower than the inner wall 58 of the cart 50, the attaching means 15 for connecting the platform 10 to the side walls 52 of the shopping cart 50 should be raised an inch and a half from the platform 10 surface.

As shown in FIG. 1-3, the Work Station 5 has a container 30 that the employee can use to store and retrieve small items. Connecting means 40 such as screws 42 and bolts 44 are used for attaching the container 30 to the platform 10 in the preferred embodiment of this invention. In an alternative embodiment not shown, the Work Station could be molded as one piece of plastic, thereby eliminating the need for screws and bolts to secure the container to the platform.

While the description above refers to particular embodiments of the present invention, it will be understood that modifications may be made without departing from the spirit thereof. The presently disclosed embodiments are therefore to be considered in all respects as illustrative and not restrictive.

What is claimed is:

1. A work station comprising:
a shopping cart;
a platform;
attaching means for connecting said platform to said shopping cart;
said platform has retaining means for holding at least one instrument;
wherein said retaining means are capable of holding said instruments of various sizes; and
wherein an employee needs to utilizes at least one instrument to perform at least one work related task, said employee can remove said instrument from said retaining means to perform said task and said employee can store said instrument in said retaining means when said employee is done with said instrument.

2. The work station of claim 1, wherein said instruments are chosen from the group consisting of pricing devices, marking devices, scanning devices, printing devices, and computing devices.

3. A work station comprising:
a shopping cart;
a platform;
said platform has a writing surface;
said platform has attaching means for connecting said platform to said shopping cart;
said platform has retaining means for holding at least one instrument;
wherein an employee needs to utilize said writing surface, said employee can perform at least one work related task using said writing surface;
wherein said retaining means are capable of holding said instruments of various sizes; and
wherein said employee needs to utilizes at least one instrument to perform at least one work related task, said employee can remove said instrument from said retaining means to perform said task and said employee can store said instrument in said retaining means when said employee is done with said instrument.

4. The work station of claim 3, wherein said instruments are chosen from the group consisting of pricing devices, marking devices, scanning devices, printing devices, and computing devices.

5. A work station comprising:
a shopping cart;
a platform;
said platform has a stable writing surface for an employees to write on;
said platform has attaching means for connecting said platform to said shopping cart;
said platform has retaining means for holding at least one instrument;
said platform has a container for storing items that the employee uses in a store;
wherein an employee needs to utilize said writing surface, said employee can perform at least one work related task;
wherein said retaining means are capable of holding said instruments of various sizes; and
wherein said employee needs to utilizes at least one instrument to perform at least one work related task, said employee can remove said instrument from said retaining means to perform said task and said employee can store said instrument in said retaining means when said employee is done with said instrument.

6. The work station of claim 5, wherein said instruments are chosen from the group consisting of pricing devices, marking devices, scanning devices, printing devices, and computing devices.

7. A work station comprising:
a shopping cart;
a platform;
attaching means for connecting said platform to said shopping cart;
said platform has retaining means for holding at least one instrument; and
connecting means for securing the retaining means to said platform.
wherein said retaining means are capable of holding said instruments of various sizes; and
wherein an employee needs to utilizes at least one instrument to perform at least one work related task, said employee can remove said instrument from said retaining means to perform said task and said employee can store said instrument in said retaining means when said employee is done with said instrument.

8. The work station of claim 7, wherein said instruments are chosen from the group consisting of pricing devices, marking devices, scanning devices, printing devices, and computing devices.

9. The work station of claim 7, wherein said platform has a writing surface for said employee to perform at least one work related task using said writing surface.

10. The work station of claim 7, wherein said platform has a container for storing items that the employee uses when performing at least one work related task.

11. A work station comprising:
a cart;
a platform;
attaching means for connecting said platform to said cart;
said platform has retaining means for holding at least one instrument;
wherein said retaining means are capable of holding said instruments of various sizes; and
wherein an employee needs to utilizes at least one instrument to perform at least one work related task, said employee can remove said instrument from said retaining means to perform said task and said employee can store said instrument in said retaining means when said employee is done with said instrument.

12. The work station of claim 11, wherein said instruments are chosen from the group consisting of pricing devices, marking devices, scanning devices, printing devices, and computing devices.

13. The work station of claim 11, wherein said platform has a writing surface for said employee to perform at least one work related task using said writing surface.

14. The work station of claim 11, wherein said platform has a container for storing items that the employee uses when performing at least one work related task.

15. A method of using a work station comprising the steps:
providing a platform which has attaching means for connecting said platform to a cart; said platform has retaining means for holding at least one instrument; and
wherein an employee needs to utilizes at least one instrument to perform at least one work related task, said employee can remove said instrument from said retaining means to perform said task and said employee can store said instrument in said retaining means when said employee is done with said instrument.

16. The work station of claim 15, wherein said instruments are chosen from the group consisting of pricing devices, marking devices, scanning devices, printing devices, and computing devices.

17. A method of using a work station comprising the steps:
providing a cart; a platform which has attaching means for connecting said platform to said cart; said platform has a writing surface; and
wherein an employee needs to utilize said writing surface, said employee can perform at least one work related task using said writing surface.

18. The work station of claim 17, wherein said instruments are chosen from the group consisting of pricing devices, marking devices, scanning devices, printing devices, and computing devices.

19. A method of using a work station comprising the steps:
providing a cart; a platform which has attaching means for connecting a platform to said cart; said platform has a writing surface and retaining means for holding at least one instruments;
wherein an employee needs to utilize said writing surface, said employee can perform at least one work related task using said writing surface; and
wherein an employee needs to utilizes at least one instrument to perform at least one work related task, said employee can remove said instrument from said retaining means to perform said task and said employee can store said instrument in said retaining means when said employee is done with said instrument.

20. The work station of claim 19, wherein said instruments are chosen from the group consisting of pricing devices, marking devices, scanning devices, printing devices, and computing devices.
